(19) United States
(12) Patent Application Publication
(10) Pub. No.: US 2022/0299737 A1
(43) Pub. Date: Sep. 22, 2022

(54) OPTICAL SYSTEM, LENS MODULE, AND TERMINAL DEVICE

(71) Applicant: JIANGXI JINGCHAO OPTICAL CO., LTD., Nanchang, Jiangxi (CN)

(72) Inventors: Yixiang TAN, Nanchang, Jiangxi (CN); Xuwen DANG, Nanchang, Jiangxi (CN); Han XIE, Nanchang, Jiangxi (CN); Xiu LIU, Nanchang, Jiangxi (CN)

(21) Appl. No.: 17/437,385

(22) PCT Filed: Mar. 13, 2020
(86) PCT No.: PCT/CN2020/079309

§ 371 Date: Sep. 8, 2021

(51) Int. Cl. G02B 13/00; G02B 9/60; G02B 27/00

(52) U.S. Cl. CPC G02B 13/006; G02B 9/60; G02B 13/0045; G02B 27/0025

(57) ABSTRACT

Embodiments of the disclosure provide an optical system, a lens module, and a terminal device. The optical system includes in order from an object side to an image side along an optical axis: a first lens with a positive refractive power, the first lens having an object-side surface which is convex at the optical axis; a second lens with a refractive power; a third lens with a refractive power; a fourth lens with a positive refractive power, the fourth lens having an object-side surface which is concave at the optical axis and an image-side surface which is convex at the optical axis; and a fifth lens with a negative refractive power. The second lens has an image-side surface cemented with an object-side surface of the third lens. The optical system satisfies the following expression: 1.0 mm⁻¹<(n2+n3)/f [symbol] 1.4 mm⁻¹.

### RELATED APPLICATION

The present application is a National Phase of International Application No. PCT/CN2020/079309, filed Mar. 13, 2020.

### TECHNICAL FIELD

This disclosure relates to the technical field of optical imaging, and in particular to an optical system, a lens module, and a terminal device.

### BACKGROUND

With the development of science and technology and the popularization of smart phones and smart electronic devices, devices with image capturing functions are widely favored by people.

In order to reduce the weight and cost of mobile smart devices, plastic lenses have been used for most imaging lenses, which improves the molding efficiency and facilitates mass production of lenses. However, the separate plastic lenses have light weights and small sizes, while the number of pieces is increasing. As such, it is difficult to control the off-axis and offset during the lens assembly process by adopting an assembly method of negative pressure adsorption, which makes it difficult to improve yield.

How to design an optical lens device for image capturing that facilitates to improving the assembly yield has become a research and development direction of industry.

### SUMMARY

Embodiments of the disclosure provide an optical system, a lens module, and a terminal device. The optical system is easy to assemble, facilitates to improve an assembly yield, and is low in assembly-sensitivity.

In a first aspect, an optical system is provided. The optical system includes multiple lenses arranged in order from an object side to an image side along an optical axis. The multiple lenses includes a first lens with a positive refractive power; a second lens with a refractive power; a third lens with a refractive power; a fourth lens with a positive refractive power; and a fifth lens with a negative refractive power. The first lens has an object-side surface which is convex at the optical axis. The fourth lens has an object-side surface which is concave at the optical axis and an image-side surface which is convex at the optical axis. The second lens has an image-side surface cemented with an object-side surface of the third lens. The optical system satisfies the following expression: 1.0 mm⁻¹<(n2+n3)/f≤1.4 mm⁻¹, where n2 represents a refractive index of the second lens, n3 represents a refractive index of the third lens, and f represents an effective focal length of the optical system.

By constraining surface profiles and refractive powers of the first lens to the fifth lens and a range of (n2+n3)/f, and cementing the second lens and the third lens to be a cemented lens, coaxial alignment of the second lens and the third lens can be omitted during the assembly process, which facilitates to improve the assembly yield and lower the assembly-sensitivity of the optical system.

In a case that the second lens and the third lens are combined as a cemented lens, by limiting the range of (n2+n3)/f and properly configuring the refractive powers of the second lens and the third lens, a chromatic aberration and a spherical aberration can be minimized, and an image quality can be improved. Compared to separate lenses, the cemented lens formed by mechanical combination has a better achromatic ability and a higher assembly coaxiality. Therefore, the assembly yield can be improved and an overall cost of the lenses can be reduced.

In an implementation, an object-side surface and/or an image-side surface of the fifth lens have an inflection point. By setting multiple inflection points on the fifth lens, the distortion and field curvature produced by the first lens, the second lens, the third lens, and the fourth lens can be corrected, such that the refractive power close to the imaging surface is more uniform. Restrictions on the refractive powers of the first lens to the fifth lens and restrictions on the inflection points on the fifth lens facilitate to improve the image quality.

In an implementation, the optical system satisfies the following expression: −1.8<f23/f<11.5, where f23 represents a composite focal length of the second lens and the third lens, and f represents the effective focal length of the optical system. The cemented lens facilitates to decrease the chromatic aberration. The proper distribution of refractive powers of the second lens and the third lens can help to gradually diffuse lights and avoid a larger deflection angle of light caused by the fourth lens and the fifth lens. By limiting −1.8<f23/f<11.5, the aberration produced by the cemented lens formed by the second lens and the third lens can be significantly compressed, thus improving the image quality and reducing the assembly-sensitivity.

In an implementation, the optical system satisfies the following expression: −3.8<(|f2|+|f3|)/R31<4.3, where f2 represents an effective focal length of the second lens, f3 represents an effective focal length of the third lens, and R31 represents a radius of curvature of an object-side surface of the third lens at the optical axis. The cemented lens facilitates to decrease the chromatic aberration. The third lens cooperates with the cemented lens to adjust the refractive power, which helps to decrease the overall spherical aberration, chromatic aberration, and distortion of the first lens, the second lens, and the third lens to a reasonable range, so as to reduce design difficulty of the fourth lens and the fifth lens. By limiting the range of (|f2|+|f3|)/R31, distribution of radius of curvature on the third lens can be proper, which can avoid an overly complex surface profile and is helpful for forming and manufacturing of the lenses.

In an implementation, the optical system satisfies the following expression: 0.1<f/|f3|<0.8, where f3 represents an effective focal length of the third lens, and f represents the effective focal length of the optical system. The proper distribution of the refractive power of the third lens can help to gradually diffuse lights and avoid a larger deflection angle of light caused by the fourth lens and the fifth lens. By limiting the range of f/|f3|, the aberration generated by the third lens can be significantly compressed, thus improving the image quality and reducing the assembly-sensitivity.

In an implementation, the optical system satisfies the following expression: 1.4<EPD/SD31<1.9, where EPD represents an entrance pupil diameter of the optical system, and SD31 represents an optical effective radius of an object-side surface of the third lens. By properly configuring the range of EPD/SD31, the third lens has an optical aperture similar to that of the first lens, which is advantageous to a smaller size of the optical system, the arrangement of the lenses, and compression of the size of the lens module. Moreover, the deflection angle of light can be decreased and sensitivity of the system can be reduced.

In an implementation, the optical system satisfies the following expression: 5<(|f1|+|f2|+|f3|)/f<14, where f1 represents an effective focal length of the first lens, f2 represents an effective focal length of the second lens, f3 represents an effective focal length of the third lens, and f represents the effective focal length of the optical system. By limiting the range of (|f1|+|f2|+|f3|)/f and properly configuring sizes and refractive powers of the first lens, the second lens, and the third lens, a larger spherical aberration generated by the first lens, the second lens, and the third lens can be effectively avoided, and overall resolution of the optical system can be improved. Moreover, sizes of the first lens, the second lens, and the third lens can be compressed, which facilitates to form an optical lens with a small size.

In an implementation, the optical system satisfies the following expression: 1.2≤|R41|/f4<2.9, where R41 represents a radius of curvature of an object-side surface of the fourth lens at the optical axis, and f4 represents an effective focal length of the fourth lens. By properly configuring the range of |R41|/f4 and setting the refractive power and radius of curvature of the fourth lens, the fourth lens can have a low-complexity surface profile, such that increase of the meridional field curvature and distortion can be suppressed to a certain extent, which facilitates to reduce difficulty of forming and improve the overall image quality.

In an implementation, the optical system satisfies the following expression: |R41/R51|<6, where R41 represents a radius of curvature of an object-side surface of the fourth lens at the optical axis, and R51 represents a radius of curvature of an object-side surface of the fifth lens at the optical axis. The fourth lens with the positive refractive power may increase the spherical aberration of the system components. The configuration of multiple inflection points on the fifth lens reasonably distributes the refractive power in a vertical direction and controls the overall aberration of the optical system, which helps to reduce a size of a dispersion spot.

In an implementation, the optical system satisfies the following expression: 1<(|SAG51|+SAG52)/CT5<2.5, where SAG51 represents an axial distance from an intersection of an object-side surface of the fifth lens and the optical axis to a vertex of a maximum effective radius of the object-side surface of the fifth lens, SAG52 represents an axial distance from an intersection of an image-side surface of the fifth lens and the optical axis to a vertex of a maximum effective radius of the image-side surface of the fifth lens, and CT5 represents a thickness of the fifth lens along the optical axis. The proper range of (|SAG51|+SAG52)/CT5 can effectively control the refractive power and thickness of the lens in the vertical direction, prevent the lens from being too thin or too thick, decrease an incident angle of light on the image surface, and reduce the sensitivity of the optical system.

In an implementation, the optical system satisfies the following expression: 3.4 mm<TTL<4.1 mm, where TTL represents a distance from an object-side surface of the first lens to an imaging surface of the optical system along the optical axis. Restriction to TTL can facilitates miniaturization of the optical system.

In an implementation, the optical system satisfies the following expression: 74°≤FOV≤92°, wherein FOV represents a maximum angel of view of the optical system.

In a second aspect, a lens module is provided. The lens module includes a lens barrel and the optical system of any implementation described above. The optical system is installed in the lens barrel.

In a third aspect, a terminal device is provided. The terminal device includes the lens module described above.

By constraining surface profiles and refractive powers of the first lens to the fifth lens and the range of (n2+n3)/f and cementing the second lens and the third lens to be a cemented lens in the optical system, the assembly yield of the optical system can be improved, and the optical system can have a low sensitivity and is easy to realize a small size.

### BRIEF DESCRIPTION OF THE DRAWINGS

In order to more clearly describe the technical solutions in the embodiments of the present disclosure or the background art, the following will describe the drawings that need to be used in the embodiments of the present disclosure or the background art.

FIG. 1 is a schematic diagram illustrating an optical system applied in a terminal device according to the present disclosure.

FIG. 2 is a schematic structural diagram of an optical system according to a first embodiment of the present disclosure.

FIG. 3 is a spherical aberration curve of the optical system of the first embodiment.

FIG. 4 is an astigmatic curve of the optical system of the first embodiment.

FIG. 5 is a distortion curve of the optical system of the first embodiment.

FIG. 6 is a schematic structural diagram of an optical system according to a second embodiment of the present disclosure.

FIG. 7 is a spherical aberration curve of the optical system of the second embodiment.

FIG. 8 is an astigmatic curve of the optical system of the second embodiment.

FIG. 9 is a distortion curve of the optical system of the second embodiment.

FIG. 10 is a schematic structural diagram of an optical system according to a third embodiment of the present disclosure.

FIG. 11 is a spherical aberration curve of the optical system of the third embodiment.

FIG. 12 is an astigmatic curve of the optical system of the third embodiment.

FIG. 13 is a distortion curve of the optical system of the third embodiment.

FIG. 14 is a schematic structural diagram of an optical system according to a fourth embodiment of the present disclosure.

FIG. 15 is a spherical aberration curve of the optical system of the fourth embodiment.

FIG. 16 is an astigmatic curve of the optical system of the fourth embodiment.

FIG. 17 is a distortion curve of the optical system of the fourth embodiment.

FIG. 18 is a schematic structural diagram of an optical system according to a fifth embodiment of the present disclosure.

FIG. 19 is a spherical aberration curve of the optical system of the fifth embodiment.

FIG. 20 is an astigmatic curve of the optical system of the fifth embodiment.

FIG. 21 is a distortion curve of the optical system of the fifth embodiment.

### DETAILED DESCRIPTION

The following will describe embodiments of the disclosure in conjunction with the accompanying drawing.

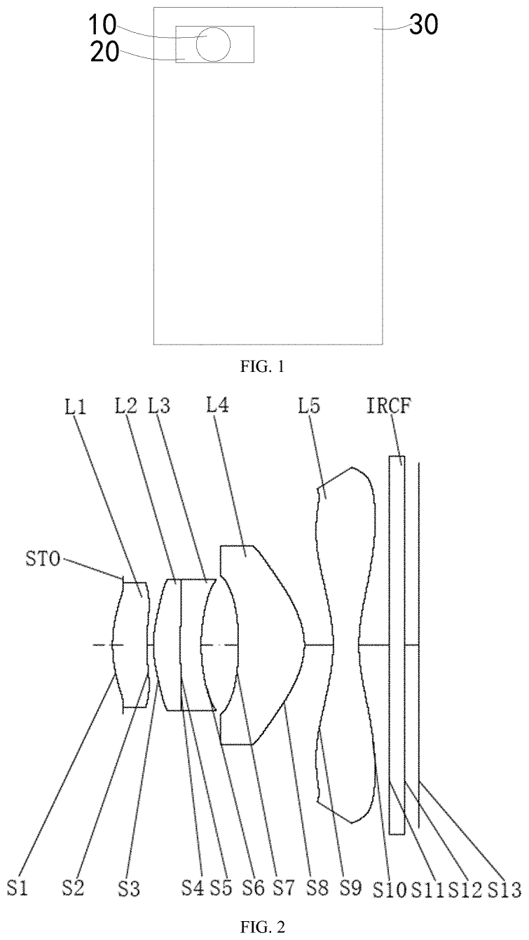

Referring to FIG. 1, an optical system 10 of the disclosure is applied in a lens module 20 in a terminal device 30. The terminal device 30 may be a mobile phone, a surveillance equipment, an in-vehicle device, etc. The optical system 10 is installed in a lens barrel of the lens module 20. The lens module 20 is assembled inside the terminal device 30.

In an implementation, the optical system provided by the disclosure includes five lenses. The five lenses include along an optical axis, in order from an object side to an image side, a first lens, a second lens, a third lens, a fourth lens, and a fifth lens. The second lens and the third lens are combined as a cemented lens, which facilitates to decrease the chromatic aberration.

The surface profiles and refractive powers of the five lenses are as follows.

The first lens has a positive refractive power. The first lens has an object-side surface which is convex at the optical axis. The second lens has a refractive power. The third lens has a refractive power. The fourth lens has a positive refractive power. The fourth lens has an object-side surface which is concave at the optical axis and an image-side surface which is convex at the optical axis. The fifth lens has a negative refractive power.

The second lens has an image-side surface cemented with an object-side surface of the third lens. The optical system satisfies the following expression: 1.0 mm⁻¹<(n2+n3)/f≤1.4 mm⁻¹, where n2 represents a refractive index of the second lens, n3 represents a refractive index of the third lens, and f represents an effective focal length of the optical system.

By constraining surface profiles and refractive powers of the first lens to the fifth lens and the range of (n2+n3)/f in the optical system, and cementing the second lens and the third lens to be cemented as a cemented lens, the assembly yield of the optical system can be improved and the optical system can have a lower assembly-sensitivity.

In the following, the disclosure will be described in detail by five embodiments.

### First Embodiment

As shown in FIG. 2, a line in the center represents an optical axis. The left side of the optical system represents an object side, and the right side represents an image side. In the optical system of this embodiment, there are a stop STO, a first lens L1, a second lens L2, a third lens L3, a fourth lens L4, a fifth lens L5, and an infrared filter IRCF in order from the object side to the image side along the optical axis. The second lens L2 and the third lens L3 are set to be a cemented lens. The cemented lens facilitates to decrease the chromatic aberration.

The first lens L1 has a positive refractive power and is made of plastic. The first lens L1 has an object-side surface S1 which is convex both at the optical axis and at the circumference and an image-side surface S2 which is concave at the optical axis and convex at the circumference. The object-side surface S1 and the image-side surface S2 are both aspheric surfaces.

The second lens L2 has a positive refractive power and is made of plastic. The second lens L2 has an object-side surface S3 which is convex both at the optical axis and at the circumference and an image-side surface S4 which is concave at the optical axis and convex at the circumference. The object-side surface S3 and the image-side surface S4 are both aspheric surfaces.

The third lens L3 has a negative refractive power and is made of plastic. The third lens L3 has an object-side surface S5 which is convex at the optical axis and concave at the circumference and an image-side surface S6 which is concave both at the optical axis and at the circumference. The object-side surface S5 and the image-side surface S6 are both aspheric surfaces.

The fourth lens L4 has a positive refractive power and is made of plastic. The fourth lens L4 has an object-side surface S7 which is concave both at the optical axis and at the circumference and an image-side surface S8 which is convex both at the optical axis and at the circumference. The object-side surface S7 and the image-side surface S8 are both aspheric surfaces.

The fifth lens L5 has a negative refractive power and is made of plastic. The fifth lens L5 has an object-side surface S9 which is concave both at the optical axis and at the circumference and an image-side surface S10 which is concave at the optical axis and convex at the circumference. The object-side surface S9 and the image-side surface S10 are both aspheric surfaces.

In a direction from the object side to the image side, the infrared filter IRCF is arranged after the fifth lens L5. The infrared filter IRCF includes an object-side surface S11 and an image-side surface S12. The infrared filter IRCF is used to filter out infrared light, such that light incident to the imaging surface is visible light. The visible light has a wavelength ranged from 380 nm-780 nm. The infrared filter IRCF is made of glass.

Table 1a illustrates characteristics of the optical system of this embodiment, where Y radius (that is, radius of curvature), thickness, and focal length are in units of millimeter (mm).

TABLE 1a
First embodiment
f = 3.169, FNO = 2.08, FOV = 74.03, TTL = 4.07

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | Infinity | 400.00 | | | | |
| surface | surface | | | | | | | |
| STO | Stop | spheric | Infinity | −0.141 | | | | |
| S1 | First | aspheric | 1.670 | 0.455 | plastic | 1.545 | 55.912 | 9.687297 |
| S2 | lens | aspheric | 2.206 | 0.090 | | | | |
| S3 | Second lens | aspheric | 1.447 | 0.354 | plastic | 1.545 | 55.912 | 4.127678 |
| S4/S5 | Third | aspheric | 4.176 | 0.282 | plastic | 1.661 | 20.412 | −4.162695 |
| S6 | lens | aspheric | 2.464 | 0.497 | | | | |
| S7 | Fourth | aspheric | −3.381 | 0.876 | plastic | 1.545 | 55.912 | 2.023164 |
| S8 | lens | aspheric | −0.909 | 0.385 | | | | |
| S9 | Fifth | aspheric | −1.756 | 0.341 | plastic | 1.545 | 55.912 | −1.714844 |
| S10 | lens | aspheric | 2.143 | 0.399 | | | | |
| S11 | Infrared | spheric | Infinity | 0.210 | glass | 1.516 | 64.048 | |
| S12 | filter | spheric | Infinity | 0.180 | | | | |
| S13 | Imaging | spheric | Infinity | 0.000 | | | | |
| | surface | | | | | | | |

Note:
a reference wavelength is 546 nm

In Table 1a, f represents an effective focal length of the optical system, FNO represents an F-number of the optical system, FOV represents an angle of view in a diagonal direction of the optical system, TTL represents a distance from the object-side surface of the first lens to the imaging surface of the optical system along the optical axis.

S4/S5 refers to the image-side surface of the second lens and the object-side surface of the third lens. The image-side surface S4 of the second lens and the object-side surface S5 of the third lens are cemented together, so that these two surfaces are reflected in data as one surface.

In this embodiment, the object-side surface and the image-side surface of any lens of the first lens L1 to the fifth lens L5 are both aspheric surfaces. The surface profiles of respective aspheric lens can be defined by but is not limited to the following equation:

$$Z = \frac{c {r}^{2}}{1 + \sqrt{1 - ( k + 1 ) {c}^{2} {r}^{2}}} + {\sum }_{i} {Air}^{i}$$

Where Z represents a distance from a respective point on the aspheric surface to a plane tangential to a vertex of the surface, r represents a distance from a respective point on the aspheric surface to the optical axis, c represents a curvature of the vertex of the aspheric surface, k represents a conic constant, Ai represents a coefficient of order i in the equation of aspheric surface profile, such as A4, A6, or A8.

Table 1b shows high order coefficients A4, A6, A8, A10, A12, A14, A16, A18, and A20 which can be used for respective aspheric surfaces S1, S2, S3, S4/S5, S6, S7, S8, S9, S10 in the first embodiment.

TABLE 1b
First embodiment
aspheric coefficients

| Surface number | S1 | S2 | S3 | S4/S5 | S6 |
|---|---|---|---|---|---|
| K | 6.5740E−02 | −1.9881E+01 | −1.6324E+00 | −9.5293E+01 | 5.4411E+00 |
| A4 | −2.7067E−02 | −2.4432E−01 | −2.4007E−01 | −1.8504E−01 | −3.0632E−02 |
| A6 | −1.0656E+00 | 2.8957E−01 | 1.0423E−01 | −5.0879E−01 | 9.7095E−03 |
| A8 | 1.0542E+01 | −4.0829E+00 | −5.8091E−01 | 8.4631E+00 | 1.1271E−01 |
| A10 | −6.3263E+01 | 2.1179E+01 | 1.7463E+00 | −3.7678E+01 | −1.2338E+00 |
| A12 | 2.3190E+02 | −6.0749E+01 | 2.5500E−01 | 8.3743E+01 | 3.1537E+00 |
| A14 | −5.3069E+02 | 1.0649E+02 | −6.6713E+00 | −1.0305E+02 | −3.5931E+00 |
| A16 | 7.3880E+02 | −1.1353E+02 | 1.0508E+01 | 7.0923E+01 | 2.1028E+00 |
| A18 | −5.7266E+02 | 6.7692E+01 | −6.7745E+00 | −2.5529E+01 | −6.2088E−01 |
| A20 | 1.8963E+02 | −1.7325E+01 | 1.5877E+00 | 3.7425E+00 | 7.3520E−02 |

| Surface number | S7 | S8 | S9 | S10 |
|---|---|---|---|---|
| K | 1.1478E+01 | −7.4267E+00 | −4.5538E+00 | −1.9679E+01 |
| A4 | −2.9004E−02 | −6.4525E−01 | 2.4762E−01 | 8.1203E−02 |
| A6 | −2.6122E−01 | 1.6772E+00 | −4.5444E−01 | −1.7911E−01 |
| A8 | 1.6162E+00 | −3.0958E+00 | 5.1205E−01 | 1.7106E−01 |
| A10 | −4.9569E+00 | 3.7631E+00 | −3.6177E−01 | −9.8502E−02 |
| A12 | 9.0400E+00 | −2.7995E+00 | 1.6674E−01 | 3.6126E−02 |
| A14 | −1.0085E+01 | 1.1282E+00 | −5.0018E−02 | −8.4760E−03 |
| A16 | 6.6652E+00 | −1.3548E−01 | 9.3847E−03 | 1.2287E−03 |
| A18 | −2.3727E+00 | −5.6061E−02 | −9.9715E−04 | −9.9878E−05 |
| A20 | 3.4858E−01 | 1.5744E−02 | 4.5655E−05 | 3.4626E−06 |

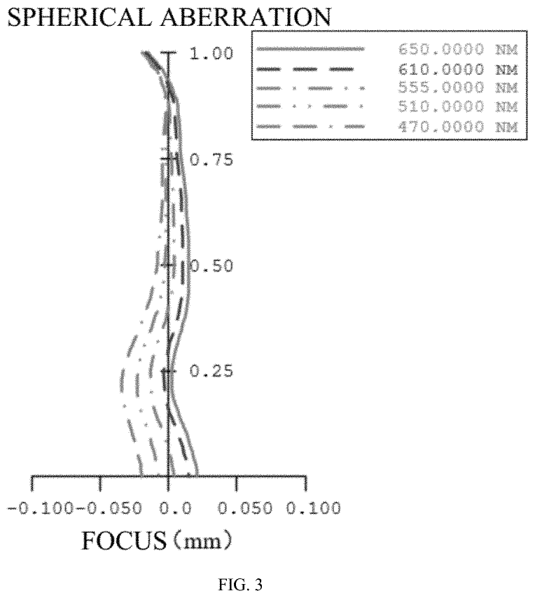

FIG. 3 illustrates a spherical aberration curve of the optical system of the first embodiment, which shows focus deviation of lights of different wavelengths after passing through lenses in the optical system.

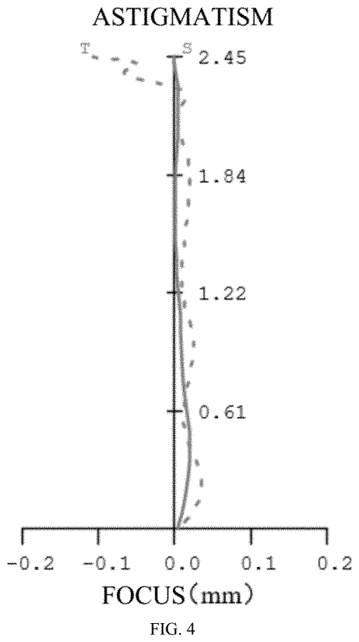

FIG. 4 illustrates an astigmatic curve of the optical system of the first embodiment, which shows blending of a meridional image plane and a sagittal image plane.

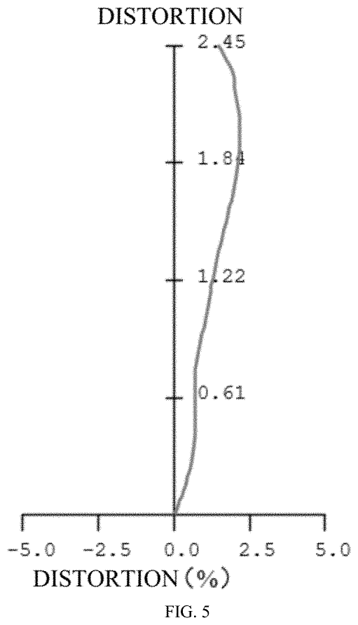

FIG. 5 illustrates a distortion curve of the optical system of the first embodiment, which shows distortion values corresponding to different angles of view.

As can be seen from FIG. 3, FIG. 4, and FIG. 5, the optical system of the first embodiment can achieve a good image quality.

### Second Embodiment

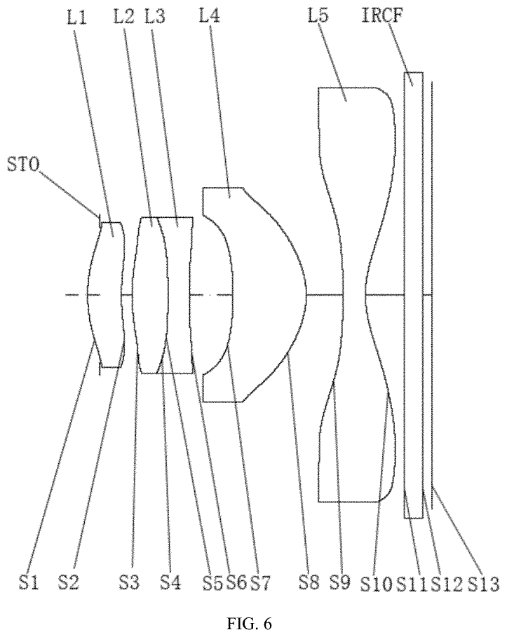

As shown in FIG. 6, a line in the center represents an optical axis. The left side of the optical system represents an object side, and the right side represents an image side. In the optical system of this embodiment, there are a stop STO, a first lens L1, a second lens L2, a third lens L3, a fourth lens L4, a fifth lens L5, and an infrared filter IRCF in order from the object side to the image side along the optical axis. The second lens L2 and the third lens L3 are set to be a cemented lens. The cemented lens facilitates to decrease the chromatic aberration.

The first lens L1 has a positive refractive power and is made of plastic. The first lens L1 has an object-side surface S1 which is convex both at the optical axis and at the circumference and an image-side surface S2 which is concave at the optical axis and convex at the circumference. The object-side surface S1 and the image-side surface S2 are both aspheric surfaces.

The second lens L2 has a positive refractive power and is made of plastic. The second lens L2 has an object-side surface S3 which is convex both at the optical axis and at the circumference and an image-side surface S4 which is convex both at the optical axis and at the circumference. The object-side surface S3 and the image-side surface S4 are both aspheric surfaces.

The third lens L3 has a negative refractive power and is made of plastic. The third lens L3 has an object-side surface S5 which is concave both at the optical axis and at the circumference and an image-side surface S6 which is concave both at the optical axis and at the circumference. The object-side surface S5 and the image-side surface S6 are both aspheric surfaces.

The fourth lens L4 has a positive refractive power and is made of plastic. The fourth lens L4 has an object-side surface S7 which is concave both at the optical axis and at the circumference and an image-side surface S8 which is convex both at the optical axis and at the circumference. The object-side surface S7 and the image-side surface S8 are both aspheric surfaces.

The fifth lens L5 has a negative refractive power and is made of plastic. The fifth lens L5 has an object-side surface S9 which is concave both at the optical axis and at the circumference and an image-side surface S10 which is concave at the optical axis and convex at the circumference. The object-side surface S9 and the image-side surface S10 are both aspheric surfaces.

The infrared filter IRCF is disposed after the fifth lens L5 in order from the object side to the image side. The infrared filter IRCF includes an object-side surface S11 and an image-side surface S12. The infrared filter IRCF is used to filter out infrared light, such that light coming into the imaging surface is visible light. The visible light has a wavelength ranged from 380 nm-780 nm. The infrared filter IRCF is made of glass.

Table 2a illustrates characteristics of the optical system of this embodiment, where Y radius (that is, radius of curvature), thickness, and focal length are in units of millimeter (mm).

TABLE 2a
Second embodiment
f = 2.829, FNO = 1.85, FOV = 79.88, TTL = 3.892

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | Infinity | 400.00 | | | | |
| surface | surface | | | | | | | |
| STO | Stop | spheric | Infinity | −0.135 | | | | |
| S1 | First | aspheric | 1.574 | 0.382 | plastic | 1.545 | 55.912 | 7.165493 |
| S2 | lens | aspheric | 2.407 | 0.121 | | | | |
| S3 | Second lens | aspheric | 2.116 | 0.404 | plastic | 1.545 | 55.912 | 6.504503 |
| S4/S5 | Third | aspheric | −65.577 | 0.243 | plastic | 1.661 | 20.412 | −7.899497 |
| S6 | lens | aspheric | 5.344 | 0.496 | | | | |
| S7 | Fourth | aspheric | −3.542 | 0.829 | plastic | 1.545 | 55.912 | 2.003843 |
| S8 | lens | aspheric | −0.905 | 0.416 | | | | |
| S9 | Fifth | aspheric | −5.537 | 0.253 | plastic | 1.545 | 55.912 | −1.757877 |
| S10 | lens | aspheric | 1.179 | 0.437 | | | | |
| S11 | Infrared | spheric | Infinity | 0.210 | glass | 1.516 | 64.048 | |
| S12 | filter | spheric | Infinity | 0.100 | | | | |
| S13 | Imaging | spheric | Infinity | 0.000 | | | | |
| | surface | | | | | | | |

Note:
a reference wavelength is 546 nm

In Table 2a, frepresents an effective focal length of the optical system, FNO represents an F-number of the optical system, FOV represents an angle of view in a diagonal direction of the optical system, TTL represents a distance from the object-side surface of the first lens to the imaging surface of the optical system along the optical axis.

S4/S5 refers to the image-side surface of the second lens and the object-side surface of the third lens. The image-side surface S4 of the second lens and the object-side surface S5 of the third lens are cemented together, so that these two surfaces are reflected in data as one surface.

Table 2b shows high order coefficients A4, A6, A8, A10, A12, A14, A16, A18, and A20 which can be used for respective aspheric surfaces S1, S2, S3, S4/S5, S6, S7, S8, S9, S10 in the second embodiment. The surface profiles of respective aspheric surfaces may be defined by the equation given in the first embodiment.

TABLE 2b
Second embodiment
aspheric coefficients

| Surface number | S1 | S2 | S3 | S4/S5 | S6 |
|---|---|---|---|---|---|
| K | −1.2288E−01 | −1.5865E+01 | −1.4734E+00 | −9.9000E+01 | 1.2228E+01 |
| A4 | −6.2050E−03 | −1.3381E−01 | −1.0923E−01 | −2.8003E−01 | −4.0489E−02 |
| A6 | −1.1630E+00 | 3.4757E−01 | −4.0092E−01 | −1.0337E+00 | −1.7955E−01 |
| A8 | 1.1420E+01 | −6.4397E+00 | 1.7444E+00 | 8.7403E+00 | 8.5637E−01 |
| A10 | −6.9595E+01 | 3.4989E+01 | −8.6450E+00 | −2.6878E+01 | −2.5305E+00 |
| A12 | 2.5907E+02 | −1.1293E+02 | 2.5842E+01 | 4.3666E+01 | 3.8957E+00 |
| A14 | −6.0190E+02 | 2.2719E+02 | −4.2969E+01 | −4.0493E+01 | −3.1874E+00 |
| A16 | 8.4980E+02 | −2.7657E+02 | 4.1956E+01 | 2.1423E+01 | 1.4234E+00 |
| A18 | −6.6783E+02 | 1.8586E+02 | −2.2585E+01 | −6.0028E+00 | −3.2956E−01 |
| A20 | 2.2424E+02 | −5.2718E+01 | 5.1077E+00 | 6.9032E−01 | 3.1055E−02 |

| Surface number | S7 | S8 | S9 | S10 |
|---|---|---|---|---|
| K | 1.3492E+01 | −4.8795E+00 | 5.2489E+00 | −3.8590E+00 |
| A4 | −6.6462E−02 | −1.6260E−01 | 1.3638E−01 | −9.4244E−02 |
| A6 | −8.6161E−03 | −8.6072E−01 | −4.6584E−01 | −4.8013E−03 |
| A8 | −6.8207E−01 | 5.0597E+00 | 5.9276E−01 | 5.2890E−02 |
| A10 | 1.9231E+00 | −1.3877E+01 | −4.2642E−01 | −4.0570E−02 |
| A12 | −2.5788E+00 | 2.1990E+01 | 1.9370E−01 | 1.6014E−02 |
| A14 | 2.8683E−01 | −2.1124E+01 | −5.5648E−02 | −3.7313E−03 |
| A16 | 2.2432E+00 | 1.2080E+01 | 9.6133E−03 | 5.1183E−04 |
| A18 | −1.7414E+00 | −3.7616E+00 | −8.8471E−04 | −3.7573E−05 |
| A20 | 3.9108E−01 | 4.8913E−01 | 3.1431E−05 | 1.0987E−06 |

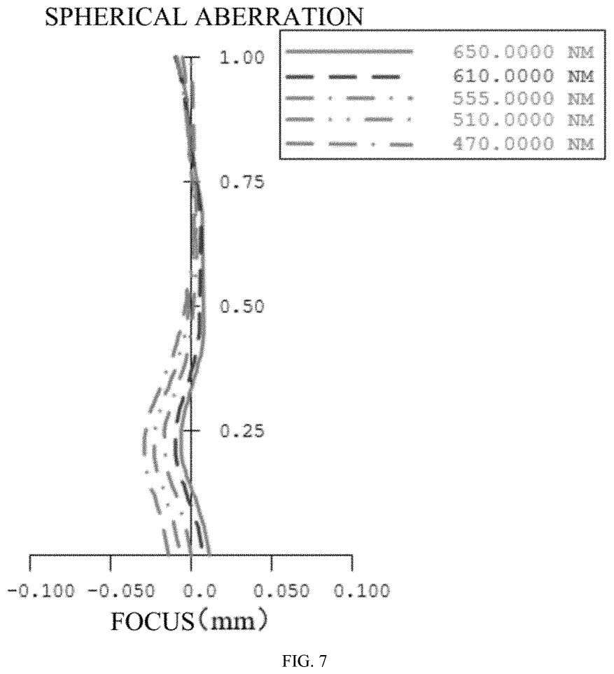

FIG. 7 illustrates a spherical aberration curve of the optical system of the second embodiment, which shows focus deviation of lights of different wavelengths after passing through lenses in the optical system.

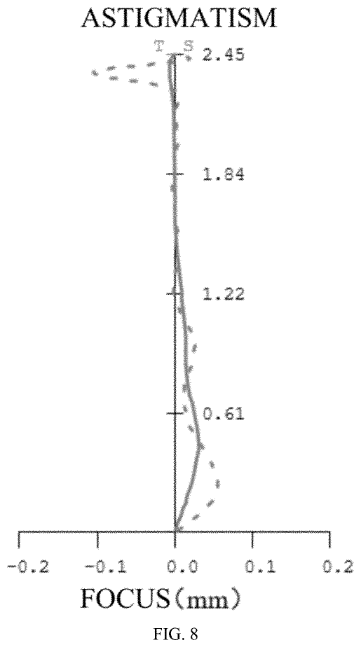

FIG. 8 illustrates an astigmatic curve of the optical system of the second embodiment, which shows blending of a meridional image plane and a sagittal image plane.

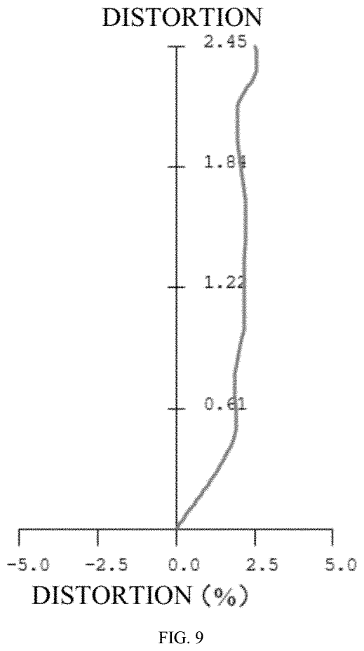

FIG. 9 illustrates a distortion curve of the optical system of the second embodiment, which shows distortion values corresponding to different angles of view.

As can be seen from FIG. 7, FIG. 8, and FIG. 9, the optical system of the second embodiment can achieve a good image quality.

### Third Embodiment

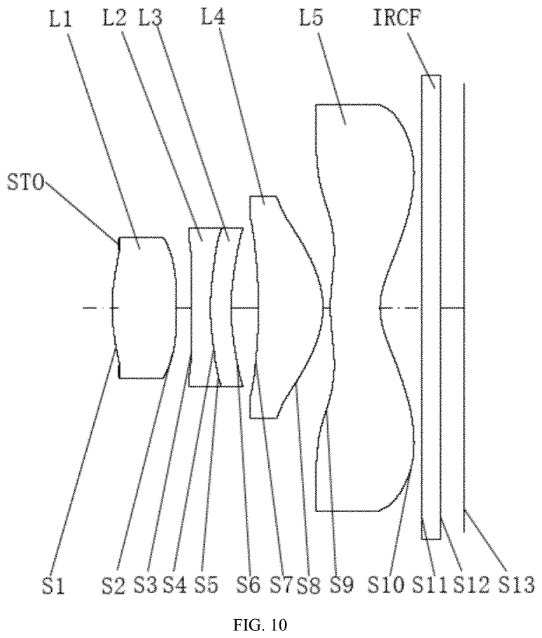

As shown in FIG. 10, a line in the center represents an optical axis. The left side of the optical system represents an object side, and the right side represents an image side. In the optical system of this embodiment, there are a stop STO, a first lens L1, a second lens L2, a third lens L3, a fourth lens L4, a fifth lens L5, and an infrared filter IRCF in order from the object side to the image side along the optical axis. The second lens L2 and the third lens L3 are set to be a cemented lens. The cemented lens facilitates to decrease the chromatic aberration.

The first lens L1 has a positive refractive power and is made of plastic. The first lens L1 has an object-side surface S1 which is convex both at the optical axis and at the circumference and an image-side surface S2 which is convex both at the optical axis and at the circumference. The object-side surface S1 and the image-side surface S2 are both aspheric surfaces.

The second lens L2 has a positive refractive power and is made of plastic. The second lens L2 has an object-side surface S3 which is convex at the optical axis and concave at the circumference and an image-side surface S4 which is concave both at the optical axis and at the circumference. The object-side surface S3 and the image-side surface S4 are both aspheric surfaces.

The third lens L3 has a negative refractive power and is made of plastic. The third lens L3 has an object-side surface S5 which is convex both at the optical axis and at the circumference and an image-side surface S6 which is concave both at the optical axis and at the circumference. The object-side surface S5 and the image-side surface S6 are both aspheric surfaces.

The fourth lens L4 has a positive refractive power and is made of plastic. The fourth lens L4 has an object-side surface S7 which is concave both at the optical axis and at the circumference and an image-side surface S8 which is convex both at the optical axis and at the circumference. The object-side surface S7 and the image-side surface S8 are both aspheric surfaces.

The fifth lens L5 has a negative refractive power and is made of plastic. The fifth lens L5 has an object-side surface S9 which is convex at the optical axis and concave at the circumference and an image-side surface S10 which is concave at the optical axis and convex at the circumference. The object-side surface S9 and the image-side surface S10 are both aspheric surfaces.

The infrared filter IRCF is disposed after the fifth lens L5 in order from the object side to the image side. The infrared filter IRCF includes an object-side surface S11 and an image-side surface S12. The infrared filter IRCF is used to filter out infrared light, such that light coming into the imaging surface is visible light. The visible light has a wavelength ranged from 380 nm-780 nm. The infrared filter IRCF is made of glass.

Table 3a illustrates characteristics of the optical system of this embodiment, where Y radius (that is, radius of curvature), thickness, and focal length are in units of millimeter (mm).

TABLE 3a
Third embodiment
f = 2.619, FNO = 2.09, FOV = 84.616, TTL = 3.792

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | Infinity | 400.00 | | | | |
| surface | surface | | | | | | | |
| STO | Stop | spheric | Infinity | −0.063 | | | | |
| S1 | First | aspheric | 2.042 | 0.692 | plastic | 1.545 | 55.912 | 3.121422 |
| S2 | lens | aspheric | −9.053 | 0.159 | | | | |
| S3 | Second lens | aspheric | 4.198 | 0.210 | plastic | 1.661 | 20.412 | 12.1879865 |
| S4/S5 | Third | aspheric | 3.704 | 0.223 | plastic | 1.545 | 55.912 | −3.559653 |
| S6 | lens | aspheric | 2.208 | 0.296 | | | | |
| S7 | Fourth | aspheric | −3.799 | 0.693 | plastic | 1.545 | 55.912 | 2.188157 |
| S8 | lens | aspheric | −0.967 | 0.080 | | | | |
| S9 | Fifth | aspheric | 1.976 | 0.536 | plastic | 1.545 | 55.912 | −2.329409 |
| S10 | lens | aspheric | 0.700 | 0.448 | | | | |
| S11 | Infrared | spheric | Infinity | 0.210 | glass | 1.516 | 64.048 | |
| S12 | filter | spheric | Infinity | 0.246 | | | | |
| S13 | Imaging | spheric | Infinity | 0.000 | | | | |
| | surface | | | | | | | |

Note:
a reference wavelength is 546 nm

In Table 3a, f represents an effective focal length of the optical system, FNO represents an F-number of the optical system, FOV represents an angle of view in a diagonal direction of the optical system, TTL represents a distance from the object-side surface of the first lens to the imaging surface of the optical system along the optical axis.

S4/S5 refers to the image-side surface of the second lens and the object-side surface of the third lens. The image-side surface S4 of the second lens and the object-side surface S5 of the third lens are cemented together, so that these two surfaces are reflected in data as one surface.

Table 3b shows high order coefficients A4, A6, A8, A10, A12, A14, A16, A18, and A20 which can be used for respective aspheric surfaces S1, S2, S3, S4/S5, S6, S7, S8, S9, S10 in the third embodiment. The surface profiles of respective aspheric surfaces may be defined by the equation given in the first embodiment.

TABLE 3b
Third embodiment
aspheric coefficients

| Surface number | S1 | S2 | S3 | S4/S5 | S6 |
|---|---|---|---|---|---|
| K | 3.4746E−01 | −6.6091E+01 | −2.9026E+00 | 9.7295E+00 | 2.2101E+00 |
| A4 | −9.5839E−02 | −4.0252E−01 | −3.5026E−01 | 7.2245E−01 | −1.8087E−01 |
| A6 | 2.3774E−01 | −2.1132E−01 | −3.1590E−01 | −3.1885E+00 | −5.1355E−01 |
| A8 | −3.1998E+00 | 4.0467E+00 | 2.8061E−01 | −3.7567E+00 | 4.3863E+00 |
| A10 | 1.9829E+01 | −2.5338E+01 | 3.9835E+00 | 5.5869E+01 | −1.6047E+01 |
| A12 | −9.3268E+01 | 9.8073E+01 | −3.9716E+00 | −1.7724E+02 | 3.5388E+01 |
| A14 | 3.3321E+02 | −2.3065E+02 | −1.8570E+01 | 3.1668E+02 | −4.8953E+01 |
| A16 | −8.2056E+02 | 3.1606E+02 | 4.9594E+01 | −3.5841E+02 | 4.1585E+01 |
| A18 | 1.1706E+03 | −2.2991E+02 | −4.5831E+01 | 2.4113E+02 | −1.9745E+01 |
| A20 | −7.0827E+02 | 6.7799E+01 | 1.5061E+01 | −7.2532E+01 | 3.9832E+00 |

| Surface number | S7 | S8 | S9 | S10 |
|---|---|---|---|---|
| K | 1.2683E+01 | −4.1846E+00 | −2.3179E+01 | −3.7887E+00 |
| A4 | 3.1071E−01 | −2.5084E−01 | −2.0620E−01 | −2.0864E−01 |
| A6 | −1.0392E+00 | 6.0323E−01 | −5.7639E−02 | 2.1181E−01 |
| A8 | 3.3110E+00 | −1.6088E+00 | 3.8627E−01 | −1.7016E−01 |
| A10 | −7.9696E+00 | 3.4512E+00 | −5.7445E−01 | 9.9888E−02 |
| A12 | 1.3205E+01 | −5.0679E+00 | 4.7904E−01 | −4.1621E−02 |
| A14 | −1.4000E+01 | 4.7690E+00 | −2.3441E−01 | 1.1775E−02 |
| A16 | 8.8091E+00 | −2.6736E+00 | 6.6297E−02 | −2.1358E−03 |
| A18 | −2.7904E+00 | 8.0685E−01 | −9.9914E−03 | 2.2344E−04 |
| A20 | 2.6979E−01 | −1.0149E−01 | 6.1609E−04 | −1.0235E−05 |

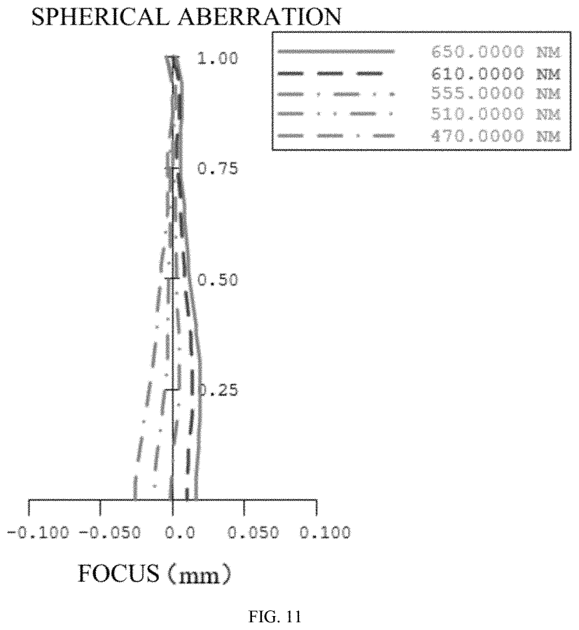

FIG. 11 illustrates a spherical aberration curve of the optical system of the third embodiment, which shows focus deviation of lights of different wavelengths after passing through lenses in the optical system.

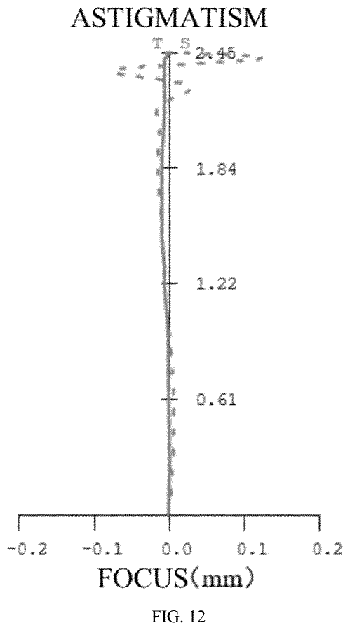

FIG. 12 illustrates an astigmatic curve of the optical system of the third embodiment, which shows blending of a meridional image plane and a sagittal image plane.

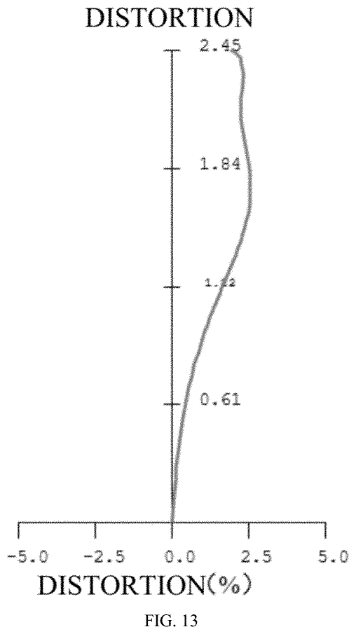

FIG. 13 illustrates a distortion curve of the optical system of the third embodiment, which shows distortion values corresponding to different angles of view.

As can be seen from FIG. 11, FIG. 12, and FIG. 13, the optical system of the third embodiment can achieve a good image quality.

### Fourth Embodiment

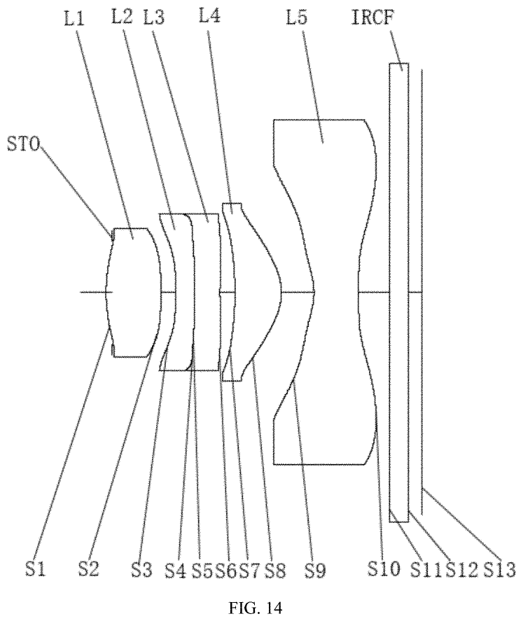

As shown in FIG. 14, a line in the center represents an optical axis. The left side of the optical system represents an object side, and the right side represents an image side. In the optical system of this embodiment, there are a stop STO, a first lens L1, a second lens L2, a third lens L3, a fourth lens L4, a fifth lens L5, and an infrared filter IRCF in order from the object side to the image side along the optical axis. The second lens L2 and the third lens L3 are set to be a cemented lens. The cemented lens facilitates to decrease the chromatic aberration.

The first lens L1 has a positive refractive power and is made of plastic. The first lens L1 has an object-side surface S1 which is convex both at the optical axis and at the circumference and an image-side surface S2 which is convex both at the optical axis and at the circumference. The object-side surface S1 and the image-side surface S2 are both aspheric surfaces.

The second lens L2 has a negative refractive power and is made of plastic. The second lens L2 has an object-side surface S3 which is concave both at the optical axis and at the circumference and an image-side surface S4 which is convex both at the optical axis and at the circumference. The object-side surface S3 and the image-side surface S4 are both aspheric surfaces.

The third lens L3 has a negative refractive power and is made of plastic. The third lens L3 has an object-side surface S5 which is concave both at the optical axis and at the circumference and an image-side surface S6 which is concave at the optical axis and convex at the circumference. The object-side surface S5 and the image-side surface S6 are both aspheric surfaces.

The fourth lens L4 has a positive refractive power and is made of plastic. The fourth lens L4 has an object-side surface S7 which is concave both at the optical axis and at the circumference and an image-side surface S8 which is convex both at the optical axis and at the circumference. The object-side surface S7 and the image-side surface S8 are both aspheric surfaces.

The fifth lens L5 has a negative refractive power and is made of plastic. The fifth lens L5 has an object-side surface S9 which is concave both at the optical axis and at the circumference and an image-side surface S10 which is convex both at the optical axis and at the circumference. The object-side surface S9 and the image-side surface S10 are both aspheric surfaces.

The infrared filter IRCF is disposed after the fifth lens L5 in order from the object side to the image side. The infrared filter IRCF includes an object-side surface S11 and an image-side surface S12. The infrared filter IRCF is used to filter out infrared light, such that light coming into the imaging surface is visible light. The visible light has a wavelength ranged from 380 nm-780 nm. The infrared filter IRCF is made of glass.

Table 4a illustrates characteristics of the optical system of this embodiment, where Y radius (that is, radius of curvature), thickness, and focal length are in units of millimeter (mm).

TABLE 4a
Fourth embodiment
f = 2.371, FNO = 2.09, FOV = 90.324, TTL = 3.45

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | Infinity | 400.00 | | | | |
| surface | surface | | | | | | | |
| STO | Stop | spheric | Infinity | −0.062 | | | | |
| S1 | First | aspheric | 1.758 | 0.600 | plastic | 1.545 | 55.912 | 2.381665 |
| S2 | lens | aspheric | −4.623 | 0.162 | | | | |
| S3 | Second lens | aspheric | −4.040 | 0.200 | plastic | 1.661 | 20.412 | −9.8598789 |
| S4/S5 | Third | aspheric | −15.024 | 0.281 | plastic | 1.545 | 55.912 | −13.7171022 |
| S6 | lens | aspheric | 6.735 | 0.164 | | | | |
| S7 | Fourth | aspheric | −3.879 | 0.509 | plastic | 1.545 | 55.912 | 1.925076 |
| S8 | lens | aspheric | −0.582 | 0.355 | | | | |
| S9 | Fifth | aspheric | −0.653 | 0.488 | plastic | 1.545 | 55.912 | −2.269593 |
| S10 | lens | aspheric | −19.510 | 0.338 | | | | |
| S11 | Infrared | spheric | Infinity | 0.210 | glass | 1.516 | 64.048 | |
| S12 | filter | spheric | Infinity | 0.144 | | | | |
| S13 | Imaging | spheric | Infinity | 0.000 | | | | |
| | surface | | | | | | | |

Note:
a reference wavelength is 546 nm

In Table 4a, f represents an effective focal length of the optical system, FNO represents an F-number of the optical system, FOV represents an angle of view in a diagonal direction of the optical system, TTL represents a distance from the object-side surface of the first lens to the imaging surface of the optical system along the optical axis.

S4/S5 refers to the image-side surface of the second lens and the object-side surface of the third lens. The image-side surface S4 of the second lens and the object-side surface S5 of the third lens are cemented together, so that these two surfaces are reflected in data as one surface.

Table 4b shows high order coefficients A4, A6, A8, A10, A12, A14, A16, A18, and A20 which can be used for respective aspheric surfaces S1, S2, S3, S4/S5, S6, S7, S8, S9, S10 in the fourth embodiment. The surface profiles of respective aspheric surfaces may be defined by the equation given in the first embodiment.

TABLE 4b
Fourth embodiment
aspheric coefficients

| Surface number | S1 | S2 | S3 | S4/S5 | S6 |
|---|---|---|---|---|---|
| K | −5.6261E−01 | −3.2089E+00 | −2.4675E+01 | −3.5258E+01 | −5.0446E+00 |
| A4 | −9.6696E−02 | −4.0179E−01 | −5.8009E−01 | 5.4032E−02 | −3.8160E−01 |
| A6 | 9.9474E−01 | −1.6674E−01 | 1.7352E+00 | 4.3697E+00 | 1.7591E+00 |
| A8 | −1.9695E+01 | 3.1488E+00 | −1.7790E+01 | −4.4586E+01 | −1.0326E+01 |
| A10 | 1.8902E+02 | −3.3044E+01 | 8.9533E+01 | 1.5691E+02 | 3.9362E+01 |
| A12 | −1.1058E+03 | 1.7604E+02 | −2.2126E+02 | −2.4384E+02 | −8.8224E+01 |
| A14 | 3.9967E+03 | −5.0698E+02 | 2.8626E+02 | 1.4598E+02 | 1.1643E+02 |
| A16 | −8.7709E+03 | 8.0181E+02 | −1.7259E+02 | 2.5284E−01 | −8.8755E+01 |
| A18 | 1.0716E+04 | −6.5332E+02 | 1.9342E+01 | 8.2000E+00 | 3.6081E+01 |
| A20 | −5.5935E+03 | 2.1339E+02 | 1.5403E+01 | −3.2474E+01 | −6.0468E+00 |

| Surface number | S7 | S8 | S9 | S10 |
|---|---|---|---|---|
| K | 1.5843E+01 | −4.1946E+00 | −4.2572E+00 | −9.9000E+01 |
| A4 | −1.5678E−01 | −9.9413E−01 | 1.2779E+00 | 8.6783E−01 |
| A6 | 1.2140E+00 | 4.3782E+00 | −3.0444E+00 | −1.6468E+00 |
| A8 | 5.2101E−02 | −8.6841E+00 | 3.5637E+00 | 1.7032E+00 |
| A10 | −2.6654E+01 | −7.1365E−01 | −2.4226E+00 | −1.1229E+00 |
| A12 | 1.1329E+02 | 3.9063E+01 | 9.1316E−01 | 4.8680E−01 |
| A14 | −2.2741E+02 | −8.4209E+01 | −1.2113E−01 | −1.3791E−01 |
| A16 | 2.4885E+02 | 8.7705E+01 | −3.5932E−02 | 2.4528E−02 |
| A18 | −1.4264E+02 | −4.6729E+01 | 1.5264E−02 | −2.4807E−03 |
| A20 | 3.3488E+01 | 1.0146E+01 | −1.6071E−03 | 1.0865E−04 |

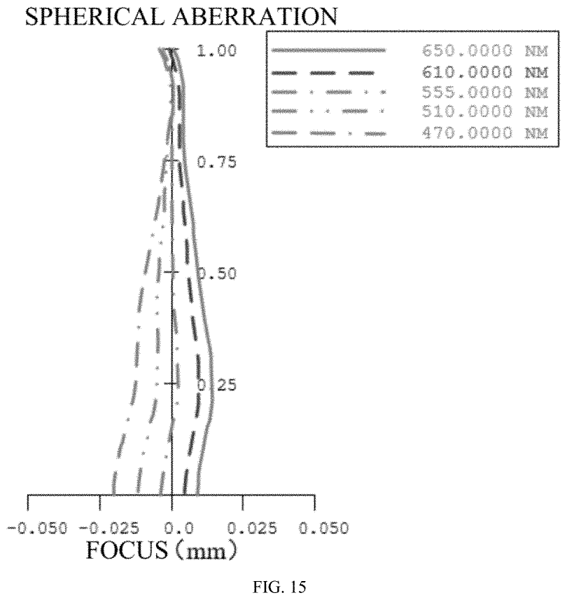

FIG. 15 illustrates a spherical aberration curve of the optical system of the fourth embodiment, which shows focus deviation of lights of different wavelengths after passing through lenses in the optical system.

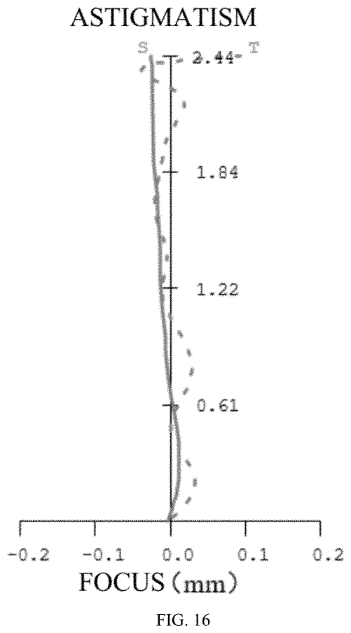

FIG. 16 illustrates an astigmatic curve of the optical system of the fourth embodiment, which shows blending of a meridional image plane and a sagittal image plane.

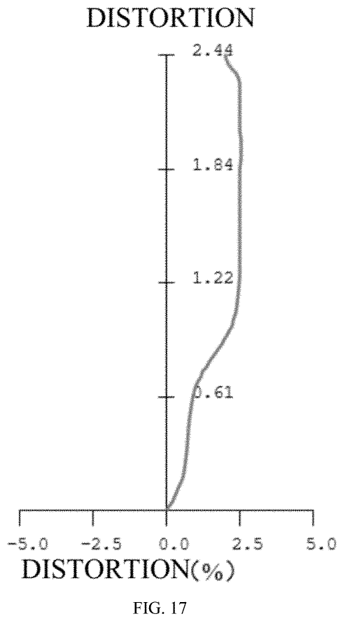

FIG. 17 illustrates a distortion curve of the optical system of the fourth embodiment, which shows distortion values corresponding to different angles of view.

As can be seen from FIG. 15, FIG. 16, and FIG. 17, the optical system of the fourth embodiment can achieve a good image quality.

### Fifth Embodiment

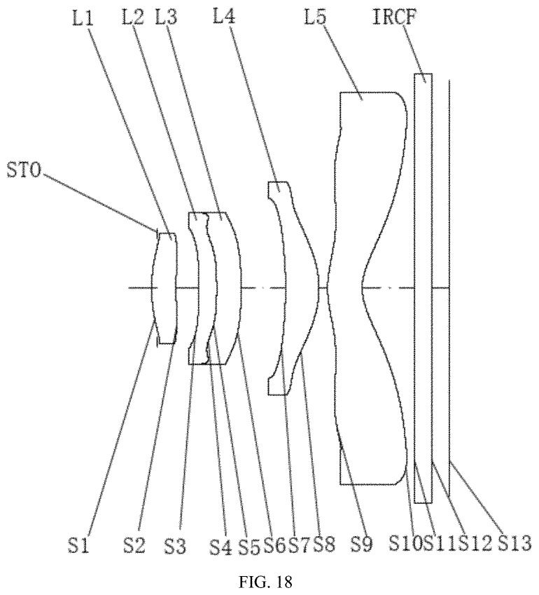

As shown in FIG. 18, a line in the center represents an optical axis. The left side of the optical system represents an object side, and the right side represents an image side. In the optical system of this embodiment, there are a stop STO, a first lens L1, a second lens L2, a third lens L3, a fourth lens L4, a fifth lens L5, and an infrared filter IRCF in order from the object side to the image side along the optical axis. The second lens L2 and the third lens L3 are set to be a cemented lens. The cemented lens facilitates to decrease the chromatic aberration.

The first lens L1 has a positive refractive power and is made of plastic. The first lens L1 has an object-side surface S1 which is convex both at the optical axis and at the circumference and an image-side surface S2 which is concave at the optical axis and convex at the circumference. The object-side surface S1 and the image-side surface S2 are both aspheric surfaces.

The second lens L2 has a negative refractive power and is made of plastic. The second lens L2 has an object-side surface S3 which is concave both at the optical axis and at the circumference and an image-side surface S4 which is convex at the optical axis and concave at the circumference. The object-side surface S3 and the image-side surface S4 are both aspheric surfaces.

The third lens L3 has a positive refractive power and is made of plastic. The third lens L3 has an object-side surface S5 which is concave at the optical axis and convex at the circumference and an image-side surface S6 which is convex both at the optical axis and at the circumference. The object-side surface S5 and the image-side surface S6 are both aspheric surfaces.

The fourth lens L4 has a positive refractive power and is made of plastic. The fourth lens L4 has an object-side surface S7 which is concave both at the optical axis and at the circumference and an image-side surface S8 which is convex both at the optical axis and at the circumference. The object-side surface S7 and the image-side surface S8 are both aspheric surfaces.

The fifth lens L5 has a negative refractive power and is made of plastic. The fifth lens L5 has an object-side surface S9 which is convex at the optical axis and concave at the circumference and an image-side surface S10 which is concave at the optical axis and convex at the circumference. The object-side surface S9 and the image-side surface S10 are both aspheric surfaces.

The infrared filter IRCF is disposed after the fifth lens L5 in order from the object side to the image side. The infrared filter IRCF includes an object-side surface S11 and an image-side surface S12. The infrared filter IRCF is used to filter out infrared light, such that light coming into the imaging surface is visible light. The visible light has a wavelength ranged from 380 nm-780 nm. The infrared filter IRCF is made of glass.

Table 5a illustrates characteristics of the optical system of this embodiment, where Y radius (that is, radius of curvature), thickness, and focal length are in units of millimeter (mm).

TABLE 5a
Fifth embodiment
f = 2.357, FNO = 2.05, FOV = 91.408, TTL = 3.48

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | Infinity | 400.00 | | | | |
| surface | surface | | | | | | | |
| STO | Stop | spheric | Infinity | −0.070 | | | | |
| S1 | First | aspheric | 1.710 | 0.287 | plastic | 1.545 | 55.912 | 4.06821 |
| S2 | lens | aspheric | 6.993 | 0.266 | | | | |
| S3 | Second lens | aspheric | −7.088 | 0.207 | plastic | 1.545 | 55.912 | −17.70769 |
| S4/S5 | Third | aspheric | −7.126 | 0.285 | plastic | 1.661 | 20.412 | 9.012069 |
| S6 | lens | aspheric | −5.226 | 0.521 | | | | |
| S7 | Fourth | aspheric | −3.714 | 0.390 | plastic | 1.545 | 55.912 | 3.010291 |
| S8 | lens | aspheric | −1.181 | 0.100 | | | | |
| S9 | Fifth | aspheric | 1.002 | 0.406 | plastic | 1.545 | 55.912 | −3.833707 |
| S10 | lens | aspheric | 0.581 | 0.608 | | | | |
| S11 | Infrared | spheric | Infinity | 0.210 | glass | 1.516 | 64.048 | |
| S12 | filter | spheric | Infinity | 0.201 | | | | |
| S13 | Imaging | spheric | Infinity | 0.000 | | | | |
| | surface | | | | | | | |

Note:
a reference wavelength is 546 nm

In Table 5a, f represents an effective focal length of the optical system, FNO represents an F-number of the optical system, FOV represents an angle of view in a diagonal direction of the optical system, TTL represents a distance from the object-side surface of the first lens to the imaging surface of the optical system along the optical axis.

S4/S5 refers to the image-side surface of the second lens and the object-side surface of the third lens. The image-side surface S4 of the second lens and the object-side surface S5 of the third lens are cemented together, so that these two surfaces are reflected in data as one surface.

Table 5b shows high order coefficients A4, A6, A8, A10, A12, A14, A16, A18, and A20 which can be used for respective aspheric surfaces S1, S2, S3, S4/S5, S6, S7, S8, S9, S10 in the fifth embodiment. The surface profiles of respective aspheric surfaces may be defined by the equation given in the first embodiment.

TABLE 5b
Fifth embodiment
aspheric coefficients

| Surface number | S1 | S2 | S3 | S4/S5 | S6 |
|---|---|---|---|---|---|
| K | −2.9753E−01 | −4.1765E+01 | 7.9987E+01 | −5.1172E+01 | −2.2062E+01 |
| A4 | −1.3108E−01 | −1.2705E−01 | −1.2477E−01 | −1.0822E+00 | −1.2883E−01 |
| A6 | 2.5697E+00 | −5.1010E−01 | −2.7252E−01 | 6.9922E+00 | −7.2779E−01 |
| A8 | −4.1796E+01 | 4.2006E+00 | −4.9933E−01 | −6.2457E+01 | 4.3317E+00 |
| A10 | 3.5466E+02 | −3.1152E+01 | 3.3177E+00 | 3.4942E+02 | −1.9833E+01 |
| A12 | −1.8164E+03 | 1.2369E+02 | −1.2713E+01 | −1.1854E+03 | 6.0715E+01 |
| A14 | 5.7472E+03 | −2.8864E+02 | 2.8367E+01 | 2.5055E+03 | −1.1603E+02 |
| A16 | −1.1038E+04 | 3.8738E+02 | −3.1056E+01 | −3.2046E+03 | 1.3234E+02 |
| A18 | 1.1819E+04 | −2.7208E+02 | 1.5738E+01 | 2.2681E+03 | −8.1582E+01 |
| A20 | −5.4249E+03 | 7.6405E+01 | −2.9108E+00 | −6.8368E+02 | 2.0741E+01 |

| Surface number | S7 | S8 | S9 | S10 |
|---|---|---|---|---|
| K | 1.1136E+01 | −5.5205E+00 | −1.3924E+01 | −3.3672E+00 |
| A4 | 4.5603E−01 | −6.3055E−01 | −1.6596E−01 | −2.0788E−01 |
| A6 | −2.3762E+00 | 3.0561E+00 | −5.9870E−02 | 1.9430E−01 |
| A8 | 8.6313E+00 | −9.8045E+00 | 2.6071E−01 | −1.3930E−01 |
| A10 | −2.1577E+01 | 2.1231E+01 | −2.5178E−01 | 7.5800E−02 |
| A12 | 3.7424E+01 | −3.0304E+01 | 1.3708E−01 | −2.9883E−02 |
| A14 | −4.4531E+01 | 2.8065E+01 | −4.5848E−02 | 8.0564E−03 |
| A16 | 3.4565E+01 | −1.6091E+01 | 9.1511E−03 | −1.3823E−03 |
| A18 | −1.5568E+01 | 5.1509E+00 | −9.7982E−04 | 1.3453E−04 |
| A20 | 3.0467E+00 | −7.0121E−01 | 4.1930E−05 | −5.6287E−06 |

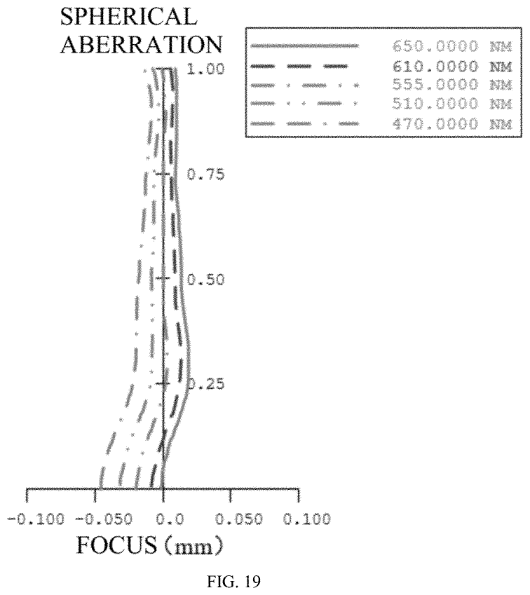

FIG. 19 illustrates a spherical aberration curve of the optical system of the fifth embodiment, which shows focus deviation of lights of different wavelengths after passing through lenses in the optical system.

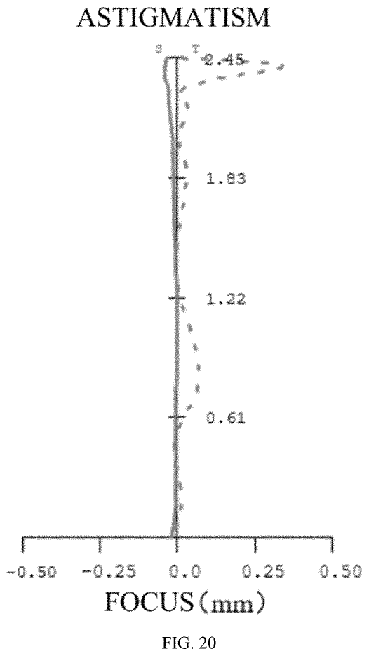

FIG. 20 illustrates an astigmatic curve of the optical system of the fifth embodiment, which shows blending of a meridional image plane and a sagittal image plane.

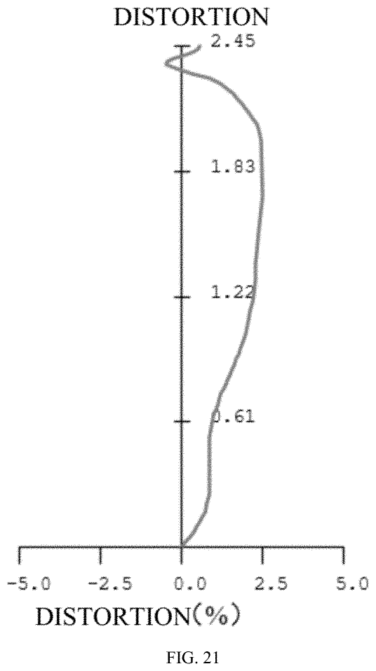

FIG. 21 illustrates a distortion curve of the optical system of the fifth embodiment, which shows distortion values corresponding to different angles of view.

As can be seen from FIG. 19, FIG. 20, and FIG. 21, the optical system of the fifth embodiment can achieve a good image quality.

Table 6 shows values of (n2+n3)/f of the optical systems in the first embodiment to the fifth embodiment. As can be seen from Table 6, the following condition is satisfied in respective embodiments: 1.0 mm⁻¹<(n2+n3)/f<1.4 mm⁻¹.

TABLE 6

| | (n2 + n3)/f |
|---|---|
| First embodiment | 1.01 |
| Second embodiment | 1.13 |
| Third embodiment | 1.22 |
| Fourth embodiment | 1.35 |
| Fifth embodiment | 1.36 |

Table 7 show values of (|SAG51|+SAG52)/CT5 of the optical systems in the first embodiment to the fifth embodiment. As can be seen from Table 7, the following condition is satisfied in respective embodiments: 1<(|SAG51|+SAG52)/CT5<2.5.

TABLE 7

| | (\|SAG51\| + SAG52)/CT5 |
|---|---|
| First embodiment | 1.30 |
| Second embodiment | 2.44 |
| Third embodiment | 0.98 |
| Fourth embodiment | 1.30 |
| Fifth embodiment | 1.66 |

Table 8 show values of (|f2|+|f3|)/R31 of the optical systems in the first embodiment to the fifth embodiment. As can be seen from Table 8, the following condition is satisfied in respective embodiments: −3.8<(|f2|+|f3|)/R31<4.3.

TABLE 8

| | (\|f2\| + \|f3\|)/R31 |
|---|---|
| First embodiment | 1.99 |
| Second embodiment | −0.22 |
| Third embodiment | 4.25 |
| Fourth embodiment | −1.57 |
| Fifth embodiment | −3.75 |

Table 9 show values of f23/f of the optical systems in the first embodiment to the fifth embodiment. As can be seen from Table 9, the following condition is satisfied in respective embodiments: −1.8<f23/f<11.5.

TABLE 9

| | f23/f |
|---|---|
| First embodiment | 1.80 |
| Second embodiment | 2.45 |
| Third embodiment | −3.44 |
| Fourth embodiment | −1.74 |
| Fifth embodiment | 11.54 |

Table 10 show values of EPD/SD31 of the optical systems in the first embodiment to the fifth embodiment. As can be seen from Table 10, the following condition is satisfied in respective embodiments: 1.4<EPD/SD31<1.9.

TABLE 10

| | EPD/SD31 |
|---|---|
| First embodiment | 1.73 |
| Second embodiment | 1.81 |
| Third embodiment | 1.52 |
| Fourth embodiment | 1.43 |
| Fifth embodiment | 1.42 |

Table 11 show values of f/|f3| of the optical systems in the first embodiment to the fifth embodiment. As can be seen from Table 11, the following condition is satisfied in respective embodiments: 0.1<f/|f3|<0.8.

TABLE 11

| | f/\|f3\| |
|---|---|
| First embodiment | 0.76 |
| Second embodiment | 0.36 |
| Third embodiment | 0.74 |
| Fourth embodiment | 0.17 |
| Fifth embodiment | 0.26 |

Table 12 show values of (|f1|+|f2|+|f3|)/f of the optical systems in the first embodiment to the fifth embodiment. As can be seen from Table 12, the following condition is satisfied in respective embodiments: 5<(|f1|+|f2|+|f3|)/f<14.

TABLE 12

| | (\|f1 + \|f2\| + \|f3\|)/f |
|---|---|
| First embodiment | 5.67 |
| Second embodiment | 7.62 |
| Third embodiment | 7.20 |
| Fourth embodiment | 10.95 |
| Fifth embodiment | 13.06 |

Table 13 show values of |R41/R51| of the optical systems in the first embodiment to the fifth embodiment. As can be seen from Table 13, the following condition is satisfied in respective embodiments: |R41/R51|<6.

TABLE 13

| | \|R41/R51\| |
|---|---|
| First embodiment | 1.93 |
| Second embodiment | 0.64 |
| Third embodiment | 1.92 |
| Fourth embodiment | 5.94 |
| Fifth embodiment | 3.71 |

Table 14 show values of |R41|/f4 of the optical systems in the first embodiment to the fifth embodiment. As can be seen from Table 14, the following condition is satisfied in respective embodiments: 1.2≤|R41|/f4<2.9.

TABLE 14

| | \|R41\|/f4 |
|---|---|
| First embodiment | 1.67 |
| Second embodiment | 1.77 |
| Third embodiment | 1.74 |
| Fourth embodiment | 2.02 |
| Fifth embodiment | 1.23 |

The above are the embodiments of this disclosure. It should be pointed out that for those of ordinary skill in the art, without departing from the principle of this disclosure, several improvements and modifications can be made, and these improvements and modifications are also considered as the scope of protection of this disclosure.

1. An optical system, comprising a plurality of lenses arranged in order from an object side to an image side along an optical axis, the plurality of lenses comprising:
a first lens with a positive refractive power, the first lens having an object-side surface which is convex at the optical axis;
a second lens with a refractive power;
a third lens with a refractive power;
a fourth lens with a positive refractive power, the fourth lens having an object-side surface which is concave at the optical axis and an image-side surface which is convex at the optical axis;
a fifth lens with a negative refractive power;
wherein the second lens has an image-side surface cemented with an object-side surface of the third lens, and the optical system satisfies the following expression:
1.0 mm−1<(n2+n3)/f≤1.4 mm−1;
wherein n2 represents a refractive index of the second lens, n3 represents a refractive index of the third lens, and f represents an effective focal length of the optical system.

2. The optical system of claim 1, wherein an object-side surface and/or an image-side surface of the fifth lens have an inflection point.

3. The optical system of claim 1, wherein the optical system satisfies the following expression:
−1.8<f23/f<11.5;
wherein f23 represents a composite focal length of the second lens and the third lens, and f represents the effective focal length of the optical system.

4. The optical system of claim 1, wherein the optical system satisfies the following expression:
−3.8<(|f2|+|f3|)/R31<4.3;
wherein f2 represents an effective focal length of the second lens, f3 represents an effective focal length of the third lens, and R31 represents a radius of curvature of an object-side surface of the third lens at the optical axis.

5. The optical system of claim 1, wherein the optical system satisfies the following expression:
0.1<f/|f3|<0.8;
wherein f3 represents an effective focal length of the third lens, and f represents the effective focal length of the optical system.

6. The optical system of claim 1, wherein the optical system satisfies the following expression:
1.4<EPD/SD31<1.9;
wherein EPD represents an entrance pupil diameter of the optical system, and SD31 represents an optical effective radius of an object-side surface of the third lens.

7. The optical system of claim 1, wherein the optical system satisfies the following expression:
5<(|f1|+|f2|+|f3|)/f<14;
wherein f1 represents an effective focal length of the first lens, f2 represents an effective focal length of the second lens, f3 represents an effective focal length of the third lens, and f represents the effective focal length of the optical system.

8. The optical system of claim 1, wherein the optical system satisfies the following expression:
1.2≤|R41|/f4<2.9;
wherein R41 represents a radius of curvature of an object-side surface of the fourth lens at the optical axis, and f4 represents an effective focal length of the fourth lens.

9. The optical system of claim 1, wherein the optical system satisfies the following expression:

|R41/R51|<6;
wherein R41 represents a radius of curvature of an object-side surface of the fourth lens at the optical axis, and R51 represents a radius of curvature of an object-side surface of the fifth lens at the optical axis.

10. The optical system of claim 1, wherein the optical system satisfies the following expression:
1<(|SAG51|+SAG52)/CT5<2.5;
wherein SAG51 represents an axial distance from an intersection of an object-side surface of the fifth lens and the optical axis to a vertex of a maximum effective radius of the object-side surface of the fifth lens, SAG52 represents an axial distance from an intersection of an image-side surface of the fifth lens and the optical axis to a vertex of a maximum effective radius of the image-side surface of the fifth lens, and CT5 represents a thickness of the fifth lens along the optical axis.

11. The optical system of claim 1, wherein the optical system satisfies the following expression:
3.4 mm<TTL<4.1 mm;
wherein TTL represents a distance from an object-side surface of the first lens to an imaging surface of the optical system along the optical axis.

12. The optical system of claim 1, wherein the optical system satisfies the following expression:
74°≤FOV≤92°;
wherein FOV represents a maximum angel of view of the optical system.

13. A lens module, comprising a lens barrel and an optical system, wherein the optical system is installed in the lens barrel, and the optical system comprises a plurality of lenses arranged in order from an object side to an image side along an optical axis, the plurality of lenses comprising:
a first lens with a positive refractive power, the first lens having an object-side surface which is convex at the optical axis;
a second lens with a refractive power;
a third lens with a refractive power;
a fourth lens with a positive refractive power, the fourth lens having an object-side surface which is concave at the optical axis and an image-side surface which is convex at the optical axis;
a fifth lens with a negative refractive power;
wherein the second lens has an image-side surface cemented with an object-side surface of the third lens, and the optical system satisfies the following expression:
1.0 mm−1<(n2+n3)/f≤1.4 mm−1;
wherein n2 represents a refractive index of the second lens, n3 represents a refractive index of the third lens, andfrepresents an effective focal length of the optical system.

14. A terminal device, comprising an lens module, wherein the lens module comprises a lens barrel and an optical system, wherein the optical system is installed in the lens barrel, and the optical system comprises a plurality of lenses arranged in order from an object side to an image side along an optical axis, the plurality of lenses comprising:
a first lens with a positive refractive power, the first lens having an object-side surface which is convex at the optical axis;
a second lens with a refractive power;
a third lens with a refractive power;
a fourth lens with a positive refractive power, the fourth lens having an object-side surface which is concave at the optical axis and an image-side surface which is convex at the optical axis;
a fifth lens with a negative refractive power;
wherein the second lens has an image-side surface cemented with an object-side surface of the third lens, and the optical system satisfies the following expression:
1.0 mm⁻¹<(n2+n3)f≤1.4 mm⁻¹;
wherein n2 represents a refractive index of the second lens, n3 represents a refractive index of the third lens, and f represents an effective focal length of the optical system.

15. The lens module of claim 13, wherein an object-side surface and/or an image-side surface of the fifth lens have an inflection point.

16. The lens module of claim 13, wherein the optical system satisfies the following expression:
−1.8<f23/f<11.5;
wherein f23 represents a composite focal length of the second lens and the third lens, and f represents the effective focal length of the optical system.

17. The lens module of claim 13, wherein the optical system satisfies the following expression:
−3.8<(|f2|+|f3|)/R31<4.3;
wherein f2 represents an effective focal length of the second lens, f3 represents an effective focal length of the third lens, and R31 represents a radius of curvature of an object-side surface of the third lens at the optical axis.

18. The terminal device of claim 14, wherein an object-side surface and/or an image-side surface of the fifth lens have an inflection point.

19. The terminal device of claim 14, wherein the optical system satisfies the following expression:
−1.8<f23/f<11.5;
wherein f23 represents a composite focal length of the second lens and the third lens, and f represents the effective focal length of the optical system.

20. The terminal device of claim 14, wherein the optical system satisfies the following expression:
−3.8<(|f2|+|f3|)/R31<4.3;
wherein f2 represents an effective focal length of the second lens, f3 represents an effective focal length of the third lens, and R31 represents a radius of curvature of an object-side surface of the third lens at the optical axis.
